(19) United States
(12) Patent Application Publication
(10) Pub. No.: US 2026/0204036 A1
(43) Pub. Date: Jul. 16, 2026

(54) IMAGE PROCESSING DEVICE AND CONTROL METHOD FOR IMAGE PROCESSING DEVICE

(71) Applicant: CANON KABUSHIKI KAISHA, Tokyo (JP)

(72) Inventor: Naoki TSUKABE, Kanagawa (JP)

(21) Appl. No.: 19/396,449

(22) Filed: Nov. 21, 2025

(30) Foreign Application Priority Data
Jan. 10, 2025 (JP) 2025-004006

(51) Int. Cl. G06T 19/20; G06T 7/60; G06T 7/70

(52) U.S. Cl. CPC G06T 19/20; G06T 7/60; G06T 7/70; G06T 2219/2004; G06T 2219/2016

(57) ABSTRACT

An image processing device includes: a processor; and a memory storing a program which, when executed by the processor, causes the image processing device to: execute acquisition processing of acquiring information on a virtual environment and information on a three-dimensional object to be arranged in the virtual environment, and execute determination processing of determining a position and size of the three-dimensional object when the three-dimensional object is arranged in the virtual environment, wherein the three-dimensional object is arranged in the virtual environment at the position and size determined in the determination processing, and a portion or all of a non-target region of the three-dimensional object, the non-target region being not to be displayed, overlaps a non-rendered region of the virtual environment.

### BACKGROUND

### Field of the Technology

The present disclosure relates to an image processing device and a control method for the image processing device.

### Description of the Related Art

Conventionally, a technique for acquiring distance distribution information by using a stereo camera, a light-field camera, and the like is known. A point cloud is obtained by performing perspective projection conversion on the distance distribution information. By polygonizing the point cloud, a three-dimensional surface model having a surface is generated. By acquiring an image (color distribution information) together with the distance distribution information or with the three-dimensional surface model generated from the distance distribution information, a 3D (three-dimensional) object including texture information can be generated. Unlike a normal two-dimensional image, the 3D object has an advantage that a user can enjoy viewing from arbitrary viewpoints.

Japanese Patent Laid-Open No. 2013-165475 discloses a technique for enabling easy identification of an object included in image data shot by a light-field camera, by creating a refocused image with a different focal distance for the image data.

In a 3D object created by using the stereo camera or the light-field camera, the entire object may not fit within an angle of view, and be cut off. The 3D object of the object that is cut off is partially missing. For example, when the 3D object of the object is combined with a background of three-dimensional space in order to further enhance a sense of immersion, the object appears to be hovering in the air because a portion of the object is missing. As described above, in a case where the 3D object in which a portion of the object is missing is combined with the background of the three-dimensional space, this may feel strange to the user.

### SUMMARY

The present disclosure provides an image processing device that reduces feeling of strangeness of an image obtained by combining a 3D object, in which a portion of an object is missing, with a background of three-dimensional space.

An image processing device according to the present disclosure includes: a processor; and a memory storing a program which, when executed by the processor, causes the image processing device to: execute acquisition processing of acquiring information on a virtual environment and information on a three-dimensional object to be arranged in the virtual environment, and execute determination processing of determining a position and size of the three-dimensional object when the three-dimensional object is arranged in the virtual environment, wherein the three-dimensional object is arranged in the virtual environment at the position and size determined in the determination processing, and a portion or all of a non-target region of the three-dimensional object, the non-target region being not to be displayed, overlaps a non-rendered region of the virtual environment.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of an image generation device.

FIG. 2 is a diagram illustrating a configuration of an imaging device.

FIG. 3 is a diagram for describing a configuration of an imaging unit.

FIGS. 4A to 4E are diagrams for describing a missing region of a 3D object.

FIG. 5 is a flowchart illustrating arrangement information determination processing for the 3D object.

FIGS. 6A and 6B are diagrams illustrating an example of arranging the 3D object.

FIGS. 7A and 7B are diagrams for describing a region in which a region of interest of a 3D object is arranged.

FIGS. 8A and 8B are diagrams for describing a region in which the entire 3D object is arranged.

FIGS. 9A to 9C are diagrams for describing the region of interest of the 3D object.

### DESCRIPTION OF THE EMBODIMENTS

Hereinafter, an embodiment of the present disclosure will be described with reference to the drawings. Note that the following embodiment does not limit the scope of the claims. The plurality of features described in the embodiment are not necessarily required, and may be arbitrarily combined. In each of the drawings, the same configurations are denoted by the same reference numerals, and redundant description will be omitted.

The present embodiment will be described with an example in which a moving image is generated by arranging a 3D object (three-dimensional object) generated by an imaging device in a virtual space (combining the 3D object in the three-dimensional space) for which a camerawork, a background, and a foreground are set in advance. Examples described in the present embodiment do not limit the present disclosure.

### Configuration

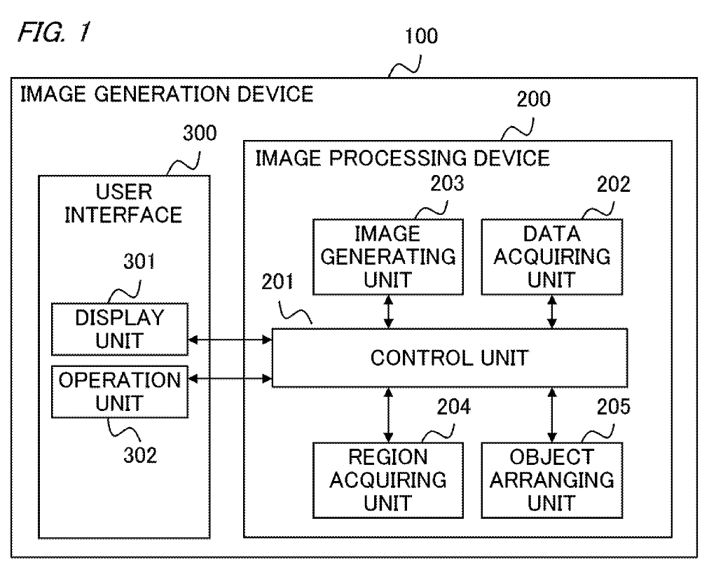

FIG. 1 is a diagram illustrating a configuration of an image generation device 100. The image generation device 100 includes an image processing device 200 and a user interface 300. Configurations of the image processing device 200 and user interface 300 according to the present disclosure will be described with reference to FIG. 1.

On the basis of information on the 3D object and information on a virtual environment, the image generation device 100 generates and outputs an image viewed from a viewpoint of a virtual camera (hereinafter, referred to as a virtual-camera viewpoint) when the virtual environment is shot.

The image processing device 200 uses the information on the 3D object and the information on the virtual environment to generate an image viewed from the virtual-camera viewpoint (hereinafter, referred to as a virtual-camera viewpoint image), and displays the generated image on the user interface 300. The user interface 300 displays to the user the virtual-camera viewpoint image obtained by viewing an inside of the virtual environment from a viewpoint set in advance as an initial value, and receives from the user various operations such as an instruction to change the viewpoint. The user interface 300 executes processing such as image display and operation reception with a dedicated application. The virtual environment includes the three-dimensional space, a plurality of components set in the three-dimensional space, and a configuration for cropping out a predetermined 3D model or two-dimensional image from the virtual environment such as a virtual camera or virtual illumination. As viewed from a virtual viewpoint, the plurality of components may be objects in the foreground and background of the 3D object to be combined, and objects at the same distance as the 3D object. The information on the virtual environment includes data of positions, sizes, and the like of the plurality of components, and information on a position of the virtual camera, a size of the angle of view of the virtual camera, and movement of the camera (camerawork) when generating a moving image using an image cropped out by the virtual camera.

The image processing device 200 is, for example, a server computer. The image processing device 200 includes a control unit 201, a data acquiring unit 202, an image generating unit 203, a region acquiring unit 204, and an object arranging unit 205. The user interface 300 is, for example, a personal computer or the like, and is electrically connected to the image processing device 200. The user interface 300 includes a display unit 301 and an operation unit 302.

The control unit 201 of the image processing device 200 includes a memory such as a read-only memory (ROM), controls the entire image processing device 200 by using a program and data stored in a memory, and implements processing of each functional unit other than the control unit 201.

The control unit 201 may include one or a plurality of pieces of dedicated hardware, and at least a part of the processing by the control unit 201 may be executed by the dedicated hardware. The dedicated hardware is, for example, an application-specific integrated circuit (ASIC), a field-programmable gate array (FPGA), a digital signal processor (DSP), or the like.

The data acquiring unit 202 acquires the information on the virtual environment and the information on the 3D object arranged in the virtual environment (combined in the three-dimensional space) from the memory included in the control unit 201 or an external I/F. From, for example, a plurality of virtual environments and 3D objects stored in the memory, the data acquiring unit 202 can acquire information on the virtual environment and 3D object selected on the user interface 300 by the user. From the imaging device 400, the data acquiring unit 202 can also acquire the information on the 3D object generated from an image captured by an imaging device 400 and depth information thereof.

The image generating unit 203 arranges the 3D object in the virtual environment and generates the virtual-camera viewpoint image of the virtual space viewed from the virtual-camera viewpoint. The image generating unit 203 arranges the 3D object in the virtual environment on the basis of a position and size of the 3D object in the virtual environment determined by the object arranging unit 205. That is, the image generating unit 203 combines the 3D object in the virtual environment, which is a three-dimensional space, on the basis of the position and size of the 3D object in the virtual environment determined by the object arranging unit 205.

The region acquiring unit 204 acquires information on a non-rendered region that is not rendered because the region is not within a field of view when the image generating unit 203 generates the virtual-camera viewpoint image. The region acquiring unit 204 acquires information on a non-target region among parts that constitute the 3D object, the non-target region being a region that is not displayed in the virtual-camera viewpoint image for some reason, such as a portion where an object is partially missing due to being cut off or the like at a time of shooting. Furthermore, the region acquiring unit 204 sets a region of interest of the 3D object, and sets a predetermined region to be a candidate for where the 3D object is arranged in the virtual environment. The object arranging unit 205 determines the position and size of the 3D object when the 3D object is arranged in the virtual environment.

Functions of the data acquiring unit 202, the image generating unit 203, the region acquiring unit 204, and the object arranging unit 205 are implemented by the control unit 201 executing programs corresponding to the respective functional units stored in the ROM. The control unit 201 temporarily stores data provided from outside via a communication I/F and data used for various calculations in a random-access memory (RAM) included in the control unit 201, and implements processing of each functional unit by using the RAM as a work area.

The display unit 301 of the user interface 300 is, for example, a liquid crystal display. The display unit 301 displays a graphical user interface (GUI) or the like for the user to operate the image processing device 200. The operation unit 302 includes, for example, a keyboard, a mouse, a joystick, and the like. Furthermore, the operation unit 302 may be configured integrally with the display unit 301, and may be, for example, a touch panel provided on a liquid crystal display. The operation unit 302 inputs various instructions based on operations from the user, to the control unit 201 of the image processing device 200.

### Generation of 3D Object

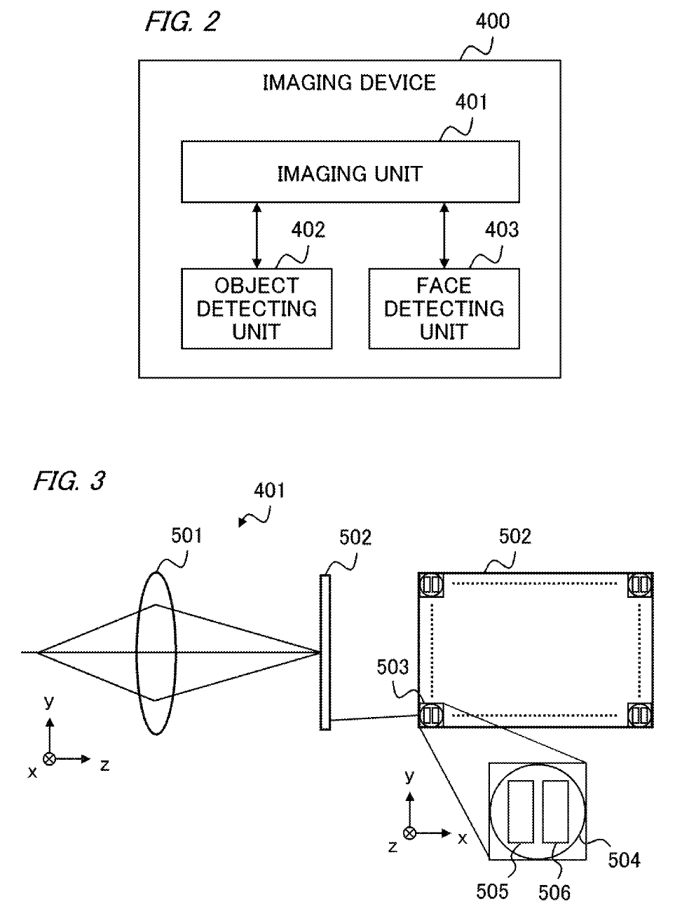

An example of a method for generating the 3D object will be described with reference to FIGS. 2 and 3. FIG. 2 is a diagram illustrating a configuration of the imaging device 400. The imaging device 400 includes an imaging unit 401, an object detecting unit 402, and a face detecting unit 403. The imaging device 400 can communicate with the image generation device 100, the image processing device 200, and the user interface 300 via a communication interface (not illustrated). FIG. 3 is a diagram for describing a configuration of the imaging unit 401. Note that the imaging device 400 may be configured integrally with the image generation device 100 or the image processing device 200.

The imaging unit 401 can shoot an object in real space to generate the 3D object. The 3D object generated by the imaging unit 401 shooting the object is saved in a storage such as a recording medium. The imaging unit 401 can transmit the information on the 3D object to the image processing device 200 and the user interface 300.

In the shooting by the imaging unit 401 for generating the 3D object, it is preferable that distance distribution information within an angle of view of the imaging unit 401 and color distribution information as viewed from the same viewpoint can be acquired. The imaging unit 401 capable of acquiring the color distribution information is, for example, a stereo camera including two imaging systems each including an optical system capable of acquiring RGB images, and an imaging element. Furthermore, the imaging unit 401 capable of acquiring the color distribution information may be a ToF camera or the like including a ToF module capable of acquiring distance distribution information and an imaging system capable of acquiring RGB images. Hereinafter, the imaging unit 401 capable of acquiring the distance distribution information and color distribution information with an imaging-surface phase-difference ranging method will be described.

In the example in FIG. 3, the imaging unit 401 includes an imaging optical system 501 and an imaging element 502. The imaging unit 401 condenses light of the object, the light being positioned on an object surface, by using the imaging optical system 501, and captures an image by exposing the imaging element 502 at a position substantially optically conjugate with the object surface.

The imaging element 502 has a structure in which about tens of millions of pixels 503 including photoelectric conversion elements are arranged in a lattice pattern, for example. Each of the pixels 503 includes a color filter that transmits a specific wavelength of red, green, or blue. The imaging element 502 can acquire the color distribution information with the pixels 503 arranged in a Bayer array, for example.

One pixel 503 includes a microlens 504, a first photoelectric converter 505, and a second photoelectric converter 506. The first photoelectric converter 505 and second photoelectric converter 506 arranged in a horizontal direction (X direction) acquire different optical information according to arrangement position thereof. From light reception information from each of the pixels 503, a first image configured as luminance distribution of light received by each first photoelectric converter 505 and a second image configured as luminance distribution of light received by each second photoelectric converter 506 are obtained.

The microlens 504 is designed such that an incident surface of the imaging element 502 and light-receiving surfaces of the first photoelectric converter 505 and second photoelectric converter 506 are substantially Fourier conjugate with each other. The light-receiving surfaces of the first photoelectric converter 505 and second photoelectric converter 506, and an exit pupil of the imaging optical system 501 are substantially optically conjugate with each other. Positional distribution on the exit pupil and positional distribution on the light-receiving surfaces of the first photoelectric converter 505 and second photoelectric converter 506 correspond to each other. By providing two different photoelectric converters, light fluxes transmitted through different pupil regions can be received separately. The first image configured as the luminance distribution of the light received by each first photoelectric converter 505 and the second image configured as the luminance distribution of the light received by each second photoelectric converter 506 are luminance distribution information obtained by the light fluxes transmitted through the different pupil regions.

Ideally, light beams that form an image on an imaging surface are incident on the same point of the imaging element 502, regardless of positions on the pupil through which the light beams pass. However, positions on the imaging element 502 on which defocused light beams are incident change depending on the positions on the pupil through which defocused light beams pass. That is, an image deviation corresponding to a defocus amount occurs.

An image deviation amount can be calculated by, for example, stereo matching between the first image and the second image. Specifically, the imaging unit 401 can calculate the image deviation amount by performing matching on a patch in a micro region of either one image, along a direction of an epipolar line on another image to identify a position having a highest correlation. The imaging unit 401 generates the 3D object by converting, into a world coordinate system, data imaged by using the calculated image deviation amount, a focal length obtained from shooting information, and a focus position.

The object detecting unit 402 groups the data imaged by the imaging unit 401 for each object (for each type of object). The object detecting unit 402 detects a region of each of the grouped objects as an object region. In a case where the detected object is a person, the face detecting unit 403 detects feature points of a face and acquires coordinates of each organ of the face. Information such as the type of the object detected by the object detecting unit 402 and the coordinates of each organ detected by the face detecting unit 403 is saved in a storage such as a recording medium, in association with the 3D object generated by the imaging unit 401.

### Missing Region of 3D Object

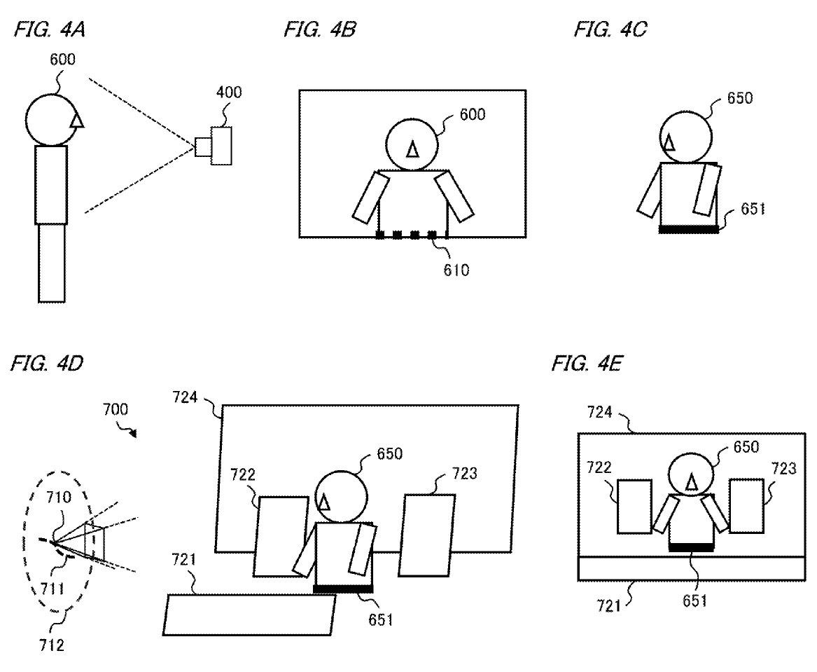

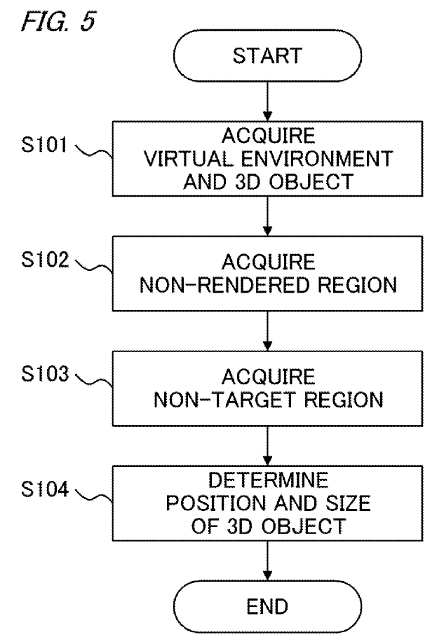

A missing region of the 3D object will be described with reference to FIGS. 4A to 4E. FIG. 4A illustrates a state where an image of a person 600 is shot by the imaging device 400. FIG. 4B illustrates a two-dimensional image of the person 600 shot in FIG. 4A. For example, in a case where the 3D object is generated from the two-dimensional image illustrated in FIG. 4B with the above-described method, a 3D object corresponding to a region below a boundary 610 (a side on feet of the person 600), which is out of a field of view of the imaging device 400, is not generated. As described above, a region missing (a region regarded as missing and not displayed) as an object for some reason in the 3D object is referred to as a missing region. FIG. 4C illustrates a 3D object 650 of the person 600, the 3D object 650 being generated from the two-dimensional image illustrated in FIG. 4B. The 3D object 650 of the person 600 is generated in a state of including a missing region 651.

FIG. 4D illustrates a state in which the 3D object 650 is arranged in a virtual environment 700. By arranging the 3D object 650 in the virtual environment 700, the image processing device 200 can generate an image that enhances a sense of immersion of the user and provides a higher-quality viewing experience.

A foreground object 721 and background objects 722 to 724 are arranged in the virtual environment 700 illustrated in FIG. 4D. The image processing device 200 can generate a virtual-camera viewpoint image as viewed from a virtual-camera viewpoint 710.

The image processing device 200 may move the virtual-camera viewpoint 710 along a virtual-camera viewpoint locus 711. By moving the virtual-camera viewpoint 710 along the virtual-camera viewpoint locus 711, the image processing device 200 can generate a moving image from the virtual-camera viewpoint 710. Furthermore, the image processing device 200 may move the virtual-camera viewpoint 710 in a virtual-camera viewpoint region 712 By moving the virtual-camera viewpoint 710 in the virtual-camera viewpoint region 712, the image processing device 200 can generate an image from the virtual-camera viewpoint 710 that is arbitrary.

FIG. 4E illustrates a virtual-camera viewpoint image in a case where the 3D object 650 is arranged in the virtual environment 700 irrespective of the missing region 651. In the virtual-camera viewpoint image illustrated in FIG. 4E, the missing region 651 of the 3D object 650 is visible, and may feel strange to the user. Therefore, in the present embodiment, the image processing device 200 determines the position and size of the 3D object to be arranged in the virtual environment 700 such that the missing region 651 of the 3D object 650 is partially or entirely invisible in the virtual-camera viewpoint image.

### Arrangement Information Determination Processing for 3D Object

FIG. 5 is a flowchart illustrating arrangement information determination processing for the 3D object. The arrangement information includes information on the position and size of the 3D object when the 3D object is arranged in the virtual environment. The image processing device 200 determines at least either the position or the size of the 3D object to be arranged in the virtual environment, on the basis of the non-rendered region that is not rendered when the virtual-camera viewpoint image is generated, and the non-target region of the 3D object, the non-target region being not displayed in the virtual-camera viewpoint image, in the three-dimensional space that constitutes the virtual environment. In the following embodiment, processing of determining both the position and size of the 3D object on the basis of information on the non-rendered region and non-target region will be described. However, the region where the non-target region is displayed in the virtual-camera viewpoint image may be reduced by determining either one.

The arrangement information determination processing illustrated in FIG. 5 is implemented by the control unit 201, which has received from the user interface 300 an instruction to generate the virtual-camera viewpoint image or to change the viewpoint, executing a program corresponding to the processing of each functional unit. The arrangement information determination processing is started when, for example, the user instructs, via the user interface 300, the image processing device 200 to generate a virtual-camera viewpoint image or to change the viewpoint.

The user can register a 3D object to be arranged in the virtual environment with the dedicated application that receives various operations from the user. The user can select a desired virtual environment and the 3D object to be arranged in the virtual environment, from among registered 3D objects and a plurality of virtual environments registered in advance, and instruct generation of the virtual-camera viewpoint image.

In step S101, the data acquiring unit 202 acquires information on the virtual environment and information on the 3D object to be arranged in the virtual environment. On the user interface 300, the data acquiring unit 202 displays, for example, a dialog that allows selection of a 3D object and a virtual environment. The data acquiring unit 202 is only required to acquire the information on the virtual environment and 3D object, the information being selected on the user interface 300 by the user.

Note that, in a case where the image processing device 200 has a function of generating a 3D object from a captured image, the data acquiring unit 202 may acquire, from the user interface 300, a captured image to be used to generate the 3D object as the information on the 3D object. The captured images held by the user interface 300 are acquired from the imaging device 400, for example. On the user interface 300, the user selects a captured image of the object instead of the 3D object of the object. The data acquiring unit 202 is only required to generate a 3D object from the captured image selected by the user.

In the following description, the 3D object is generated by the imaging device 400. Furthermore, the 3D object is an object obtained by converting a region detected as a person by the object detecting unit 402 of the imaging device 400 into 3D. The face detecting unit 403 detects facial organs from the 3D object of the person, acquires coordinates of the face organs, and records the coordinates in the storage of the imaging device 400.

In step S102, the region acquiring unit 204 acquires information on the non-rendered region in the virtual environment with respect to the viewpoint and angle of view of the virtual camera that are set via the user interface 300. On the basis of the information on the virtual environment acquired in step S101, the region acquiring unit 204 acquires information on the non-rendered region, which is a region not rendered, from a positional relationship between the virtual-camera viewpoint and each object in the virtual environment.

In a case where a pattern of the viewpoint of the virtual camera, movement (locus) of the viewpoint, or the like is determined in advance, and the information on the non-rendered region is calculated in advance and included in the information on the virtual environment, the region acquiring unit 204 is only required to acquire the information on the non-rendered region included in the information on the virtual environment. The region acquiring unit 204 may be configured to acquire the information on the non-rendered region on the basis of a relationship between the virtual-camera viewpoint and the foreground object and background object, in a case where the region acquiring unit 204 acquires the information on the virtual environment and determines that the information on the non-rendered region is not included in the information on the virtual environment.

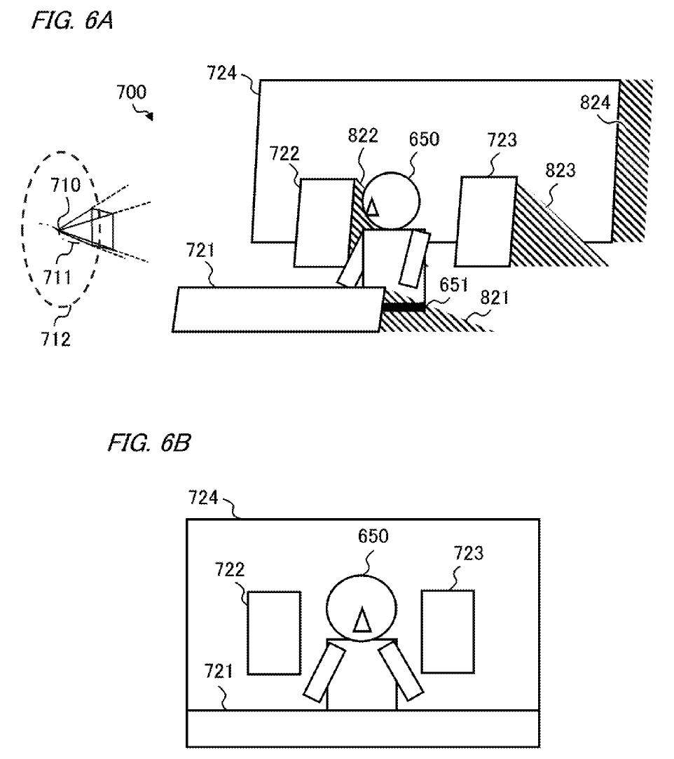

The non-rendered region will be described with reference to FIG. 6A. Non-rendered regions 821 to 824 in the virtual environment 700 are regions that are shielded by the foreground object 721 and the background objects 722 to 724, respectively as viewed from the virtual-camera viewpoint 710, and do not need to be rendered. A region outside a field of view (outside the angle of view) from the virtual-camera viewpoint 710 is also a non-rendered region.

In step S103, the region acquiring unit 204 acquires information on a non-target region of the 3D object, the non-target region being not to be displayed. In a case where the information on the non-target region is provided as meta information to the 3D object, the region acquiring unit 204 may acquire the information on the non-target region from the meta information. Furthermore, the non-target region of the 3D object may be specified by the user via the operation unit 302 of the user interface 300. In this case, the region acquiring unit 204 acquires information on the non-target region specified by the user. Furthermore, in a case where an object that is stored in advance in a database and can be detected as a specific object, such as a 3D object of a person, is the 3D object, a portion missing as an object may be determined and identified on the basis of information on portions detected in the 3D object. For example, in the 3D object of a person illustrated in FIG. 6A, a face and a torso are detected, and a lower body or legs in a lower portion of the torso are missing. Therefore, the lower portion of the torso is set as the missing region.

The non-target region is, for example, a region that the user does not want to display in the 3D object, and can be the missing region 651 including a boundary of the 3D object. In addition, the non-target region may be set to include a blur region and occluded region obtained from image analysis, an imaging condition, or the like.

In step S104, the object arranging unit 205 determines the position and size of the 3D object in the virtual environment on the basis of the non-rendered region and the non-target region. For example, the object arranging unit 205 determines the position and size of the 3D object such that at least a portion of the non-target region overlaps the non-rendered region.

The object arranging unit 205 may evaluate arrangement information (the position and size of the 3D object) by using an evaluation function representing a matching degree of the non-target region of the 3D object with respect to the non-rendered region. The matching degree of the non-target region with respect to the non-rendered region is an index indicating how much of the non-target region overlaps the non-rendered region. The object arranging unit 205 changes, by using various optimization methods, Monte Carlo methods, or the like, at least either the position or size of the 3D object to increase the matching degree from the matching degree at an initial position, and determines a final position and size of the 3D object. By determining the position and size of the 3D object such that the matching degree of the non-target region with respect to the non-rendered region is high, the object arranging unit 205 can adjust arrangement of the 3D object such that the non-target region is hidden in the non-rendered region.

By determining a suitable position and size of the 3D object, as illustrated in FIG. 6A, the object arranging unit 205 can arrange a portion or all of the missing region 651, which is a non-target region of the 3D object 650, in the non-rendered region 821 of the virtual environment 700.

The image generating unit 203 generates the virtual-camera viewpoint image in which the 3D object 650 is arranged in the virtual environment 700, on the basis of the position and size of the 3D object 650 determined by the object arranging unit 205. Because the missing region 651, which is a non-target region of the 3D object 650, is arranged in the non-rendered region 821, as illustrated in FIG. 6B, the image generating unit 203 can generate a virtual-camera viewpoint image without a feeling of strangeness in which the missing region 651 does not appear.

With the arrangement information determination processing illustrated in FIG. 5, the image processing device 200 can determine, on the basis of the non-rendered region and the non-target region, a suitable position and size of the 3D object when the 3D object is arranged in the virtual environment.

### Region in which 3D Object is Arranged in Virtual Environment

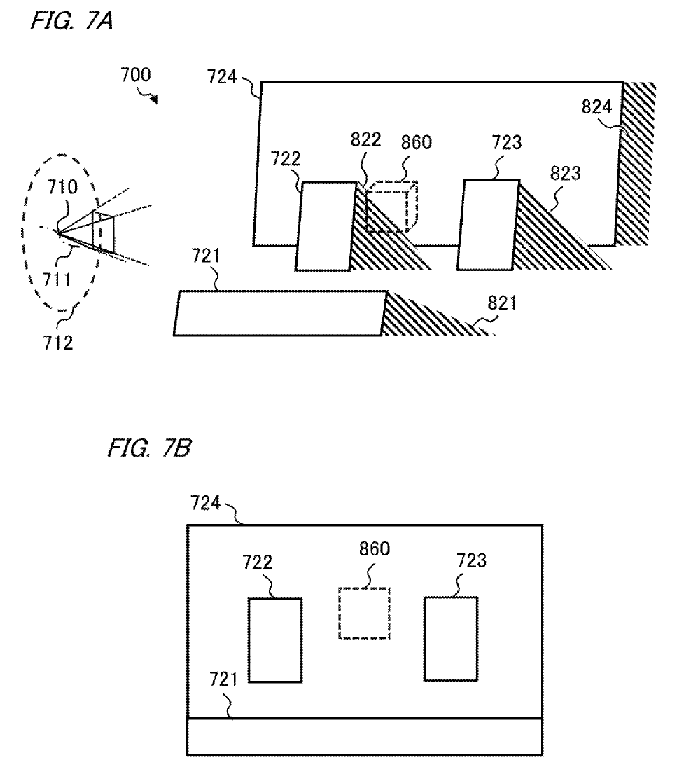

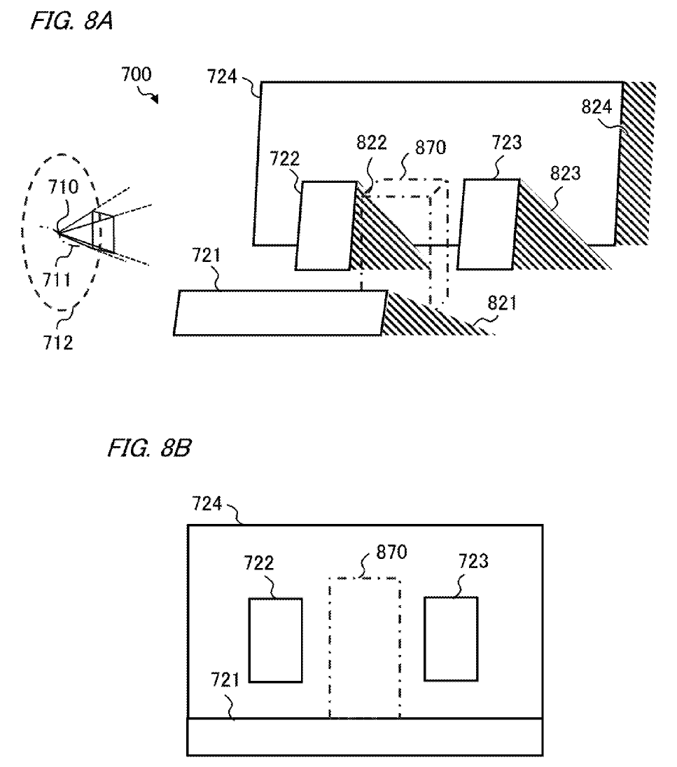

A region in which the 3D object is arranged in the virtual environment 700 will be described with reference to FIGS. 7A and 7B and FIGS. 8A and 8B. In the virtual environment 700, the image processing device 200 can generate a suitable virtual-camera viewpoint image by arranging the 3D object in a predetermined region such as, for example, a region positioned at a center as viewed from the virtual-camera viewpoint 710 or a region not overlapping other objects.

In FIGS. 7A and 8A, regions behind the foreground object 721 and the background objects 722 to 724 with respect to the virtual-camera viewpoint 710 are the non-rendered regions 821 to 824. The region outside the field of view from the virtual-camera viewpoint 710 is also the non-rendered region. On the basis of the information on the non-rendered region, the image processing device 200 can generate the virtual-camera viewpoint image in which a portion or all of the non-target region such as the missing region 651 does not appear and with which a feeling of strangeness is reduced.

In order to create an image with less feeling of strangeness, the image processing device 200 may set, in the virtual environment, a predetermined region suitable for arrangement of a region of interest in the 3D object as an object (hereinafter, referred to as the region of interest of the 3D object).

In FIG. 7A, a predetermined region 860 of the virtual environment 700 is set at a central portion of the field of view as viewed from the virtual-camera viewpoint 710. For example, the predetermined region 860 may be set in advance as a region for arranging the region of interest of the 3D object when the virtual environment 700 is created. The predetermined region 860 may be set on the basis of the field of view from the virtual-camera viewpoint 710 when the virtual environment 700 is shot. For example, the predetermined region 860 is set to a region including a center of the field of view from the virtual-camera viewpoint 710. FIG. 7B illustrates an image as viewed from the virtual-camera viewpoint 710.

The object arranging unit 205 of the image processing device 200 can determine the position and size of the 3D object on the basis of the predetermined region 860 of the virtual environment 700 and the region of interest of the 3D object. The object arranging unit 205 determines the position and size of the 3D object such that at least a portion of the region of interest of the 3D object overlaps the predetermined region 860 of the virtual environment 700.

Furthermore, the region of interest of the 3D object may be the entire object. In a case where the entire object is the region of interest of the 3D object, the image processing device 200 sets in the virtual environment the predetermined region suitable for arranging the entire 3D object.

In FIG. 8A, a predetermined region 870 of the virtual environment 700 is set between the background object 722 and the background object 723 in the field of view as viewed from the virtual-camera viewpoint 710. For example, the predetermined region 870 may be set in advance as a region for arranging the entire 3D object when the virtual environment 700 is created. The predetermined region 870 may be set on the basis of the field of view from the virtual-camera viewpoint 710 when the virtual environment 700 is shot. The predetermined region 870 may be set on the basis of a positional relationship between the foreground object 721 and the background objects 722 to 724. For example, the predetermined region 870 is set as a region that does not overlap the background objects 722 and 723 in the central portion of the field of view from the virtual-camera viewpoint 710. FIG. 8B illustrates an image as viewed from the virtual-camera viewpoint 710.

A plurality of predetermined regions in the virtual environment 700 may be set according to an object to be arranged. By setting the predetermined region 860 and the predetermined region 870 in the virtual environment 700, the image processing device 200 can arrange the region of interest of the 3D object at a more suitable position and size, and generate a natural virtual-camera viewpoint image.

### Region of Interest of the 3D Object

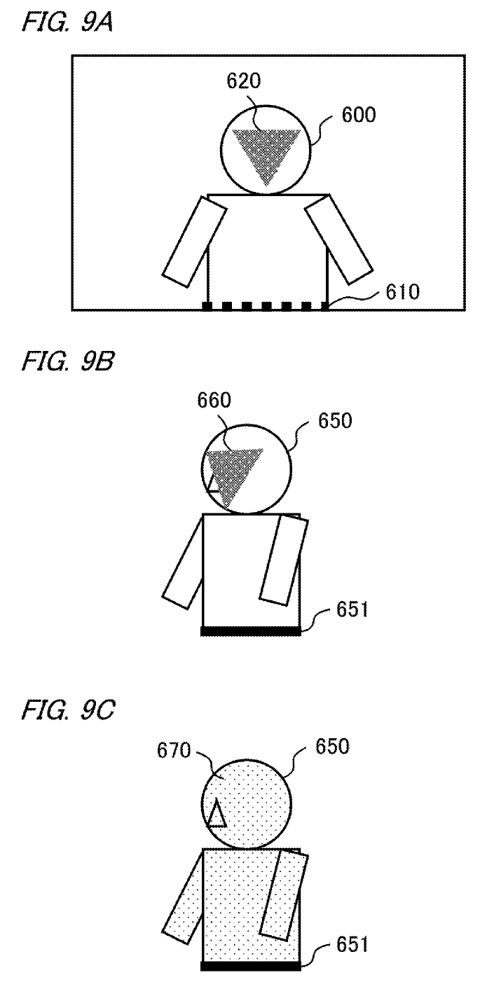

FIGS. 9A to 9C are diagrams for describing the region of interest of the 3D object. FIG. 9A illustrates a captured image used to generate the 3D object 650. The object detecting unit 402 detects from the captured image a region of the person 600 as the object region. The face detecting unit 403 detects feature points of a face of the person 600 and acquires coordinates of each organ of a face 620. Note that processing of the object detecting unit 402 and the face detecting unit 403 may be executed by the image processing device 200. By the data acquiring unit 202 acquiring the captured image from the imaging device 400, the region acquiring unit 204 can detect the region of the person 600 from the captured image and acquire the coordinates of each organ of the face 620.

Because the region of the person 600 is cut at the boundary 610 of the captured image, the region acquiring unit 204 can acquire the missing region 651 corresponding to the boundary 610 in the 3D object 650 as the non-target region. A plurality of non-target regions may be acquired.

In the 3D object 650, the region acquiring unit 204 acquires a region corresponding to the face 620, as the region of interest 660 of the 3D object. Furthermore, the region acquiring unit 204 acquires the entire 3D object 650, which is the object region, as a region of interest 670. The region acquiring unit 204 may acquire a plurality of regions of interest from the 3D object according to a purpose.

As illustrated in FIGS. 9B and 9C, from the 3D object 650, the region acquiring unit 204 can acquire the missing region 651, which is the non-target region, a region of interest 660 of the 3D object, and the region of interest 670 of the 3D object. The region acquiring unit 204 may acquire the non-target region and the region of interest by using object detection and segmentation with a method using various kinds of machine learning. Furthermore, the region acquiring unit 204 may acquire a region specified by the user via the user interface 300, as the non-target region or the region of interest.

On the basis of information on the missing region 651 that is the non-target region, the image processing device 200 can arrange the 3D object 650 such that the missing region 651 overlaps the non-rendered region. The image processing device 200 can arrange the 3D object at an appropriate position with an appropriate size by acquiring the regions of interest 660 and 670 of the 3D object 650 and arranging the same so as to overlap a predetermined region of the virtual environment 700.

### Priority of Position and Size when Arranging 3D Object

The object arranging unit 205 of the image processing device 200 may determine priority of the position and size of the 3D object before determining the arrangement of the 3D object. The object arranging unit 205 weights amounts of change in position and size of the 3D object on the basis of the priority of the position and size of the 3D object. By setting the priority of the position and size of the 3D object, the object arranging unit 205 can adjust which one, the position or the size, is prioritized to arrange the 3D object.

The object arranging unit 205 can set the priority of the position and size of the 3D object on the basis of a tone of a background image of the virtual environment. For example, in a case where the background image of the virtual environment acquired by the data acquiring unit 202 in step S101 is cel-shaded, and therefore a sense of scale is not important, the object arranging unit 205 sets the priority of the size higher than the priority of the position. By the priority of the size being set higher than the priority of the position, the image generating unit 203 can generate a powerful virtual-camera viewpoint image in which the object is largely depicted.

Meanwhile, in a case where the background image of the virtual environment has a real-life tone, and therefore the sense of scale is important, the object arranging unit 205 sets the priority of the size lower than the priority of the position. By the priority of the size being set lower than the priority of the position, the image generating unit 203 can generate a virtual-camera viewpoint image with less feeling of strangeness, without changing current dimensions of the object as much as possible. In order to arrange more importance on the sense of scale, it is also possible to adjust only the position without changing the size from the size set by default in the 3D object or the size desired by the user.

Furthermore, the object arranging unit 205 may set the priority of the position and size of the 3D object on the basis of a magnitude relationship between the predetermined region of the virtual environment and the region of interest of the 3D object.

In a case where the region of interest of the 3D object is smaller than the predetermined region of the virtual environment, the object arranging unit 205 sets the priority of the size of the 3D object to be higher than the priority of the position of the 3D object. In a case where the regions of interest 660 and 670 of the 3D object are respectively smaller than the predetermined regions 860 and 870 of the virtual environment, the priority of the size of the 3D object is set higher than the priority of the position of the 3D object.

In a case where the region of interest of the 3D object is larger than the predetermined region of the virtual environment, the object arranging unit 205 sets the priority of the size of the 3D object to be lower than the priority of the position of the 3D object. In a case where the regions of interest 660 and 670 of the 3D object are respectively larger than the predetermined regions 860 and 870 of the virtual environment, the priority of the size of the 3D object is set lower than the priority of the position of the 3D object.

Furthermore, the object arranging unit 205 may set the priority of the position and size of the 3D object on the basis of a relationship between a distance from the predetermined region of the virtual environment to the non-rendered region and a distance from the region of interest of the 3D object to the non-target region. The distance between each of the regions may be the shortest distance between the regions, or may be a distance between respective centers of gravity of the regions.

In a case where the distance from the region of interest of the 3D object to the non-target region is shorter than the distance from the predetermined region of the virtual environment to the non-rendered region, the object arranging unit 205 sets the priority of the size of the 3D object to be higher than the priority of the position of the 3D object. In a case where a distance from the region of interest 660 of the 3D object to the missing region 651 of the non-target region is shorter than a distance from the predetermined region 860 of the virtual environment to the non-rendered region, the priority of the size of the 3D object is set to be higher than the priority of the position of the 3D object.

In a case where the distance from the region of interest of the 3D object to the non-target region is longer than the distance from the predetermined region of the virtual environment to the non-rendered region, the object arranging unit 205 sets the priority of the size of the 3D object to be lower than the priority of the position of the 3D object. In a case where the distance from the region of interest 660 of the 3D object to the missing region 651, which is the non-target region, is longer than the distance from the predetermined region 860 of the virtual environment to the non-rendered region, the priority of the size of the 3D object is set to be lower than the priority of the position of the 3D object.

The object arranging unit 205 may change both the size and position of the 3D object to be arranged in the virtual environment. On the basis of the priority of the size and position, the object arranging unit 205 adjusts the amounts of change in size and position of the 3D object to be arranged in the virtual environment. By the amounts of change in size and position being adjusted appropriately, the image generating unit 203 can generate a virtual-camera viewpoint image with less feeling of strangeness.

The priority of the position and size when the 3D object is arranged in the virtual environment may be automatically set by the object arranging unit 205 according to an instruction from the control unit 201. The priority of the position and size of the 3D object can be changed by the user via the operation unit 302 of the user interface 300. By providing the GUI for changing the priority of the position and size, the user can adjust a value of the priority automatically set by the object arranging unit 205. By receiving input of the priority according to preference of the user, the image generating unit 203 can generate a virtual-camera viewpoint image without a feeling of strangeness, which is better matching an intention of the user

On the basis of the set priority, the object arranging unit 205 determines the position and size of the 3D object when the 3D object is arranged in the virtual environment. In step S104 in FIG. 5, as the priority of the position is higher, the object arranging unit 205 changes the position of the 3D object more greatly and reduces the degree of change in size. By expressing the matching degree of the non-target region of the 3D object with respect to the non-rendered region with the evaluation function, the object arranging unit 205 is only required to determine the position and size of the 3D object in the virtual environment, such that the matching degree is higher.

The evaluation function includes, for example, terms regarding an amount of change in position and an amount of change in size. The term of the amount of change in position and the term of the amount of change in size respectively have the priority of the position and the priority of the size as coefficients. When the priority of the position and size are set, the object arranging unit 205 adjusts the amount of change in position and amount of change in size of the 3D object such that the matching degree of the non- target region with respect to the non-rendered region is higher. The object arranging unit 205 can determine the position and size of the 3D object in the virtual environment on the basis of the amount of change in position and amount of change in size of the 3D object that are acquired by using the evaluation function.

### Method for Arranging 3D Object

A method for arranging the 3D object using the evaluation function will be described. The object arranging unit 205 determines the position and size of the 3D object in the virtual environment on the basis of the non-rendered region and the missing region 651 that is the non-target region. The object arranging unit 205 evaluates the arrangement of the 3D object by using the evaluation function representing the matching degree of the non-target region of the 3D object with respect to the non-rendered region. The object arranging unit 205 can hide a portion or all of the non-target region of the 3D object in the non-rendered region by adjusting the position and size of the 3D object such that the non-target region overlaps the non-rendered region.

The object arranging unit 205 may evaluate a matching degree between the non-rendered region and a region other than the non-target region (missing region 651) of the 3D object. The object arranging unit 205 determines the position and size of the 3D object such that the region other than the non-target region of the 3D object is not hidden by the non-rendered region as much as possible. That is, the object arranging unit 205 is only required to determine the position and size of the 3D object such that a matching degree between the non-rendered region and the region other than the non-target region of the 3D object is lower.

Furthermore, the object arranging unit 205 may evaluate the matching degree between the predetermined region of the virtual environment and the region of interest of the 3D object.

For example, in a case where the region acquiring unit 204 acquires the predetermined region 860 of the virtual environment and the region of interest 660 of the 3D object, a term representing the matching degree between the predetermined region 860 and the region of interest 660 is added to the evaluation function. The object arranging unit 205 is only required to determine the position and size of the 3D object such that the matching degree between the predetermined region 860 and the region of interest 660 is larger. By arranging the 3D object such that the predetermined region 860 matches the region of interest 660, the image generating unit 203 can generate a close-up virtual-camera viewpoint image of the region of interest of the 3D object.

Furthermore, in a case where the region acquiring unit 204 acquires the predetermined region 870 of the virtual environment and the region of interest 670 of the 3D object, a term representing the matching degree between the predetermined region 870 and the region of interest 670 is added to the evaluation function. The object arranging unit 205 is only required to determine the position and size of the 3D object such that the matching degree between the predetermined region 870 and the region of interest 670 is larger. By arranging the 3D object such that the predetermined region 870 and the region of interest 670 match each other, the image generating unit 203 can generate a natural virtual-camera viewpoint image without disturbing the arrangement of the entire 3D object. The method for evaluating the arrangement of the entire 3D object (region of interest 670) to determine the position and size of the 3D object is effective in a case where a face detection fails and the region of interest 660 is not acquired.

### Simple Method for Arranging 3D Object

Not limited to the method for arranging the 3D object using the evaluation function, the object arranging unit 205 can arrange the 3D object with a simple and high-speed method without using the evaluation function.

First, at the virtual-camera viewpoint 710, the object arranging unit 205 determines the size of the 3D object on the basis of the distance between the predetermined region 860 of the virtual environment 700 and the non-rendered region. The object arranging unit 205 determines the size of the 3D object such that the distance between the region of interest 660 of the 3D object and the non-target region (missing region 651) is longer than the distance between the predetermined region 860 of the virtual environment 700 and the non-rendered region. Next, the object arranging unit 205 determines the position of the 3D object such that at least a portion of the predetermined region 860 of the virtual environment and a portion of the region of interest 660 of the 3D object overlap each other.

The object arranging unit 205 can determine the position and size of the 3D object in the virtual environment on the basis of the non-rendered region and the non-target region by using a high-speed and simple method without using the evaluation function.

In the embodiment described above, the image processing device 200 determines, on the basis of the non-rendered region of the virtual environment and the non-target region of the 3D object, the position and size of the 3D object when the 3D object is arranged in the virtual environment. The image processing device 200 can reduce feeling of strangeness of the virtual-camera viewpoint image by arranging the 3D object including the non-target region in the virtual environment (by combining the 3D object with a background of a three-dimensional space) such that the non-target region overlaps the non-rendered region.

As a simpler method, the non-rendered region may be determined on the basis of a position of each component in the virtual environment with respect to the virtual-camera viewpoint 710, and the position of the 3D object alone may be changed and determined such that a portion or all of the non-target region of the 3D object overlaps the non-rendered region. Needless to say that, also in this case, the size of the 3D object may be changed for another reason (for example, for the user to display the 3D object at a desired size).

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, it is possible to reduce feeling of strangeness of an image obtained by combining a 3D object, in which a portion of an object is missing, with a background of three-dimensional space

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-004006, filed January 10, 2025, which is hereby incorporated by reference herein in its entirety.

What is claimed is:

1. An image processing device comprising:
a processor; and
a memory storing a program which, when executed by the processor, causes the image processing device to:
execute acquisition processing of acquiring information on a virtual environment and information on a three-dimensional object to be arranged in the virtual environment, and
execute determination processing of determining a position and size of the three-dimensional object when the three-dimensional object is arranged in the virtual environment,
wherein the three-dimensional object is arranged in the virtual environment at the position and size determined in the determination processing, and a portion or all of a non-target region of the three-dimensional object, the non-target region being not to be displayed, overlaps a non-rendered region of the virtual environment.

2. The image processing device according to claim 1,
wherein, in the determination processing, the position of the three-dimensional object in the virtual environment is determined on a basis of the non-rendered region and the non-target region.

3. The image processing device according to claim 1,
wherein, in the determination processing, the size of the three-dimensional object in the virtual environment is determined on a basis of the non-rendered region and the non-target region.

4. The image processing device according to claim 1,
wherein, in the determination processing, the position and size of the three-dimensional object in the virtual environment are determined on a basis of the non-rendered region and the non-target region.

5. The image processing device according to claim 1,
wherein, in the determination processing, the position and size of the three-dimensional object are determined on a basis of a predetermined region of the virtual environment and a region of interest of the three-dimensional object.

6. The image processing device according to claim 1,
wherein, in the determination processing, the position and size of the three-dimensional object are determined such that at least a portion of a region of interest of the three-dimensional object overlaps a predetermined region of the virtual environment.

7. The image processing device according to claim 1,
wherein, in the determination processing, the size of the three-dimensional object is determined such that a distance between a region of interest of the three-dimensional object and the non-target region is longer than a distance between a predetermined region of the virtual environment and the non-rendered region, and the position of the three-dimensional object is determined such that at least a portion of the predetermined region of the virtual environment and a portion of the region of interest of the three-dimensional object overlap each other.

8. The image processing device according to claim 5,
wherein the predetermined region of the virtual environment is set on a basis of at least either a field of view from a viewpoint of a virtual camera when the virtual environment is shot, or a positional relationship with another object arranged in the virtual environment.

9. The image processing device according to claim 1,
wherein the non-target region is a region including a boundary of the three-dimensional object.

10. The image processing device according to claim 1,
wherein, in the determination processing, amounts of change in the position and size of the three-dimensional object are weighted on a basis of priority of the position and size of the three-dimensional object, respectively.

11. The image processing device according to claim 10,
wherein the priority of the position and size of the three-dimensional object is set on a basis of a tone of a background image of the virtual environment.

12. The image processing device according to claim 10,
wherein, in a case where a region of interest of the three-dimensional object is smaller than a predetermined region of the virtual environment, the priority of the size of the three-dimensional object is set to be higher than the priority of the position of the three-dimensional object.

13. The image processing device according to claim 10,
wherein, in a case where a region of interest of the three-dimensional object is larger than a predetermined region of the virtual environment, the priority of the size of the three-dimensional object is set to be lower than the priority of the position of the three-dimensional object.

14. The image processing device according to claim 10,
wherein, in a case where a distance from a region of interest of the three-dimensional object to the non-target region is shorter than a distance from a predetermined region of the virtual environment to the non-rendered region, the priority of the size of the three-dimensional object is set to be higher than the priority of the position of the three-dimensional object.

15. The image processing device according to claim 10,
wherein, in a case where a distance from a region of interest of the three-dimensional object to the non-target region is longer than a distance from a predetermined region of the virtual environment to the non-rendered region, the priority of the size of the three-dimensional object is set to be lower than the priority of the position of the three-dimensional object.

16. The image processing device according to claim 10,
wherein the priority of the position and size of the three-dimensional object is able to be changed by a user.

17. The image processing device according to claim 1,
wherein, in the determination processing, the position and size of the three-dimensional object are determined by using an evaluation function that evaluates a matching degree of the non-target region with respect to the non-rendered region.

18. The image processing device according to claim 1, wherein the program which, when executed by the processor, further causes the image processing device to:
execute generation processing of generating, on a basis of the position and size of the three-dimensional object determined in the determination processing, an image in which the three-dimensional object is arranged in the virtual environment.

19. A control method for an image processing device, the control method comprising:
acquiring information on a virtual environment and information on a three-dimensional object to be arranged in the virtual environment, and
determining a position and size of the three-dimensional object when the three-dimensional object is arranged in the virtual environment,
wherein the three-dimensional object is arranged in the virtual environment at the position and size determined in the determining, and a portion or all of a non-target region of the three-dimensional object, the non-target region being not to be displayed, overlaps a non-rendered region of the virtual environment.

20. A non-transitory computer readable medium that stores a program, wherein the program causes a computer to execute a control method for an image processing device, the control method comprising:
acquiring information on a virtual environment and information on a three-dimensional object to be arranged in the virtual environment, and
determining a position and size of the three-dimensional object when the three-dimensional object is arranged in the virtual environment,
wherein the three-dimensional object is arranged in the virtual environment at the position and size determined in the determining, and a portion or all of a non-target region of the three-dimensional object, the non-target region being not to be displayed, overlaps a non-rendered region of the virtual environment.
